(19) United States
(12) Patent Application Publication
(10) Pub. No.: US 2011/0003946 A1
(43) Pub. Date: Jan. 6, 2011

(54) CURABLE REACTION RESIN SYSTEM

(76) Inventors: Klaus-Volker Schuett, Wernau (DE); Irene Jennrich, Winnenden (DE); Hans Staudenmaier, Waiblingen (DE)

Correspondence Address: KENYON & KENYON LLP, ONE BROADWAY, NEW YORK, NY, 10004, US

(21) Appl. No.: 12/735,299

(22) PCT Filed: Nov. 26, 2001
(86) PCT No.: PCT/EP08/66204

§ 371 Date: Sep. 13, 2010

(30) Foreign Application Priority Data
Jan. 18, 2008 (DE) 10 2008 005 155.1

(51) Int. Cl. C08L 63/02

(52) U.S. Cl. 525/476

(57) ABSTRACT

A curable reaction resin system is described, which is to be processed as a two-component mass and which contains a resin component, a curing agent as well as polymer particles that are dispersed in the resin component, the polymer particles being contained in the reaction resin system at a proportion of more than 25 and up to 50 wt. %.

### BACKGROUND OF THE INVENTION

1. Field of the Invention

The present invention relates to a curable reaction resin system and its use.

2. Description of Related Art

Systems based on a resin that is cured by a chemical reaction are very important in the production of technical parts and components. When such reaction resin systems are used for insulating purposes, they usually have high contents of fillers. High filler contents lead to high thermal and mechanical stability of the cured reaction resin systems.

Such reaction resin systems based on epoxy resins are known from published German patent application document DE 103 45 139 A1. These have a filler proportion of up to 90 wt. %. Higher proportions of filler are not able to be implemented using the systems described there, since otherwise there would be disadvantageous effects on viscosity and processability of the encapsulating compound. High filler contents are certainly detrimental to flowability and expandability of the material.

### SUMMARY OF THE INVENTION

The present invention is based on the object of providing a curable reaction resin system that has a high thermal stability, at the same time maintaining good elongation at break, and still is able to be processed well.

The object on which the present invention is based is attained, according to the present invention, by providing a reaction resin system that is usable as a two-component system and includes a high proportion of polymer particles dispersed in one resin component of the reaction resin. The reaction resin system has good flowability during processing, and in the cured state, has a high thermal stability and electrical insulation capability.

Thus, the reaction resin system preferably has silicone elastomer particles as polymer particles, which are surface-modified to ensure good binding to the resin matrix of the reaction resin system. The particular advantage of using silicone elastomer particles is that their addition has only a slight influence, if any, on the glass transition temperature of the system, but, at the same time, the thermal stability and the electric breakdown strength are improved. It is also advantageous that silicone elastomer particles are nonvolatile.

In one particularly advantageous specific embodiment, the reaction resin system has an epoxide as the resin component, if necessary, mixed with a bisphenol A, bisphenol B and/or bisphenol F. The resulting resin system has a high degree of cross-linking, and consequently, a high mechanical stability in the cured state.

### DETAILED DESCRIPTION OF THE INVENTION

One reaction resin system according to the present invention has three base components, namely a resin component A, a curing agent B and polymer particles C that are dispersed in resin component A. In addition, a filler D may be contained as well as usual additives, such as defoaming agents and coupling agents.

As resin component A one may basically use a plurality of monomers, cross-linkable compounds or mixtures of such compounds. Particularly advantageous is the use of compounds that have at least one epoxide function, possibly in mixtures with other compounds with or without an epoxide function Thus, di-, tri- or tetraepoxides are suitable, the commercially available compounds shown below being given as examples. Cycloaliphatic, preferably ring-epoxidized diepoxides, such as (I) and (VI), have proven especially suitable

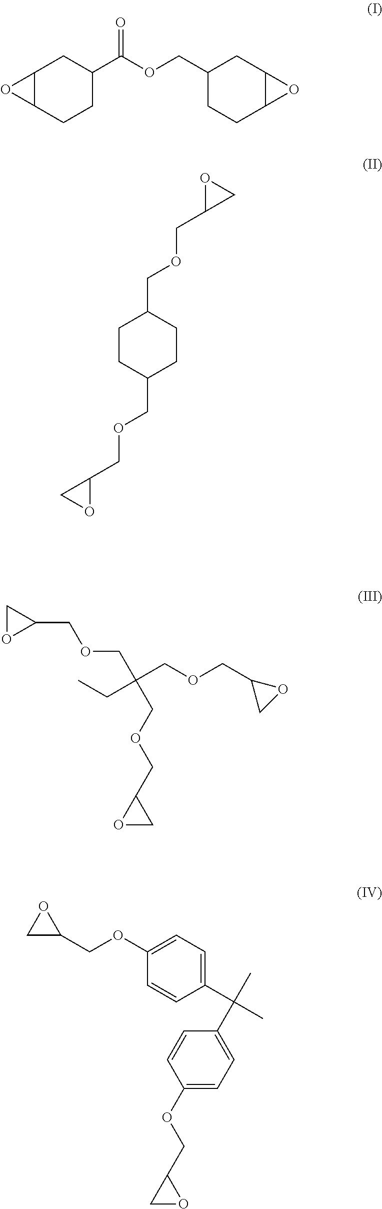

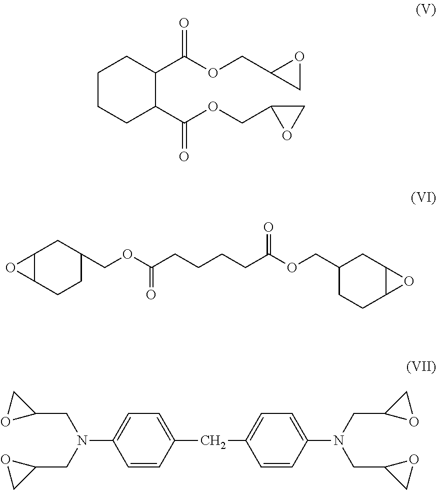

Resin component A may include one or more of compounds (I) through (VII), as well as additional resin components. Alternatively or in addition, for example, resin components based on bisphenol A, bisphenol B and/or bisphenol F, PUR or even cyanate ester by itself or in mixtures with one another or with suitable epoxide resin components may be used.

It is also possible to use a novolak epoxide resin as resin component A, particularly a cresol novolak epoxide resin of the following composition:

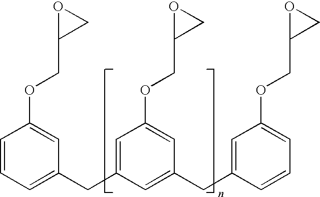

Resin component A is contained in the reaction resin system at from 5 to 65 wt. %, preferably at from 10 to 50 wt. %, especially at from 15 to 40 wt. %.

In order to ensure that the reaction resin system is workable as a two-component system, a curing agent B is also provided. For this, anhydrides such as hexahydrophthalic acid anhydride (HHPSA), hexahydromethylphthalic acid anhydride (MHHPSA), methylnadic acid anhydride (MNSA) or equivalent amines are suitable, for example.

As the third component, the reaction resin system additionally contains polymer particles C dispersed in resin component A. In this context, especially polysiloxane-containing polymers are involved, component C preferably representing a dispersion of one or more silicones in resin component A. Silicone particles in the form of silicone resin particles or silicone elastomer particles having a particle diameter of 10 nm to 100 μm are preferably used. The silicone particles may basically have a chemically modified surface in the form of a polymer layer of PMMA, for example (so-called core-shell particles); it has been shown, however, that surface-functionalized silicone particles are better suited for the problem definition on which the present invention is based. Alternatively, silicone block copolymers or elastomer particles of acrylonitrile-butadiene-styrene copolymerizate (ABS) are also suitable.

The reaction resin system contains, for example, more than 25 and up to 50 et. % polymer particles C, preferably more than 25 and up to 40 wt. %, and especially more than 25 and up to 30 wt. %.

The reaction resin system preferably contains only a small proportion of mineral fillers D, by the suitable choice of which a shrinkage of the reaction resin system in the cured state can be diminished, and thermal stability and resistance to cracking of the reaction resin system in the cured state is increased. The filler is developed, for instance, in the form of nanoparticles, by nanoparticles a particle fraction being understood whose average grain size distribution d₅₀ moves in the nanometer range. As filler materials, aluminum oxide, chalk, silicon carbide, boron nitride, soot or talcum are suitable. Filler D preferably has particles of quartz dust or translucent vitreous silica or mixtures of same.

The total proportion of filler in the reaction resin system amounts to, for instance, less than 10 wt. %, preferably less than 7 wt. %, especially less than 5 wt. %. The reaction resin system may also be developed while omitting mineral fillers.

The present reaction resin system may be used both as impregnating resin and as encapsulating compound. When processed as impregnating resin, for instance, for impregnating electrical windings, the winding in question is put into rotation and either dipped into the liquid impregnating resin or the liquid impregnating resin is applied drop by drop onto the rotating winding. The curing of the impregnated winding takes place thermally, for instance, or via UV-supported cross-linking.

If the reaction resin system is used as an encapsulating compound, the encapsulating of a structural part takes place at elevated temperature. At appropriate heating, the reaction resin system has such a low viscosity and such high capillary action that even unfavorable geometries such as casting gaps having a diameter of <300 μm may be filled during encapsulating.

In exemplary fashion, exemplary embodiments of reaction resin systems and their compositions (in wt. %) are listed below and the resulting property profile in the cured state.

### Composition:

| Application | | Comparative | |
|---|---|---|---|
| Example | 1 | Example | 2 |
| resin component A | 40 | 40 | 37 |
| | bisphenol A/ | bisphenol A/ | cycloali- |
| | epoxide | epoxide | phatic |
| | | | epoxide |
| curing agent | 33.5 | 33.5 | 38.3 |
| | HHPSA/ | MNSA | HHPSA/ |
| | MHHPSA | | MHHPSA |
| polymer particles | 26.5 | 13.25 | 25.1 |
| C/silicone | | | |
| elastomer | | | |
| fillers | | 13.25 | |
| (nanoparticles) | | | |

The compositions named above yield the following property profile:

| Exemplary | | | |
|---|---|---|---|
| Embodiment | 1 | 2 | 3 |
| glass | 125 | 146 | |
| transition | | | |
| temperature | | | |
| [° C.] | | | |
| thermal | <60 | <45 | |
| coefficient of | | | |
| expansion | | | |
| [10⁻⁶*1/° C.] | | | |
| E-module | | | 1500 |
| transverse | | | |
| bending | | | |
| test/tensile | | | |
| test [N/mm²] | | | |
| breaking | 62/41 | | 60/40 |
| stress/tearing | | | |
| stress [N/mm²] | | | |
| elongation at | 8/6 | | 8/6 |
| break/elonga- | | | |
| tion at tear | | | |
| [%] | | | |

Based on its thermal stability in the cured state, the reaction resin system is suitable, above all, for components which are exposed, at least intermittently, to temperatures of 160 to 220° C.

Thus, the reaction resin system according to the present invention may be used as an encapsulating compound, for instance for encapsulating high-voltage actuators or similar electrical or electronic components. Furthermore, electrical windings may be impregnated with the reaction resin system.

1-10. (canceled)

11. A curable reaction resin system which is usable as a two-component system, comprising:
a resin component having polymer particles dispersed therein, and
a curing agent,
wherein the proportion of polymer particles contained in the reaction resin system is more than 25 wt. % and up to 50 wt. % of the reaction resin system.

12. The reaction resin system as recited in claim 11, wherein the polymer particles are surface-modified.

13. The reaction resin system as recited in claim 11, wherein the polymer particles are developed as core-shell particles.

14. The reaction resin system as recited in claim 12, wherein the polymer particles are developed as core-shell particles.

15. The reaction resin system as recited in claim 11, wherein the polymer particles dispersed in the resin component are silicone elastomer particles.

16. The reaction resin system as recited in claim 12, wherein the polymer particles dispersed in the resin component are silicone elastomer particles.

17. The reaction resin system as recited in claim 13, wherein the polymer particles dispersed in the resin component are silicone elastomer particles.

18. The reaction resin system as recited in claim 15, wherein the silicone elastomer particles have a particle diameter of 10 nm to 100 μm.

19. The reaction resin system as recited in claim 16, wherein the silicone elastomer particles have a particle diameter of 10 nm to 100 μm.

20. The reaction resin system as recited in claim 11, wherein the resin component includes an epoxide resin.

21. The reaction resin system as recited in claim 12, wherein the resin component includes an epoxide resin.

22. The reaction resin system as recited in claim 13, wherein the resin component includes an epoxide resin.

23. The reaction resin system as recited in claim 15, wherein the resin component includes an epoxide resin.

24. The reaction resin system as recited in claim 20, wherein the epoxide resin is a resin based on a bis- or higher functional epoxide.

25. The reaction resin system as recited in claim 21, wherein the epoxide resin is a resin based on a bis- or higher functional epoxide.

26. The reaction resin system as recited in claim 11, wherein the resin component contains a resin based on at least one of bisphenol A, bisphenol B and bisphenol F.

27. The reaction resin system as recited in claim 12, wherein the resin component contains a resin based on at least one of bisphenol A, bisphenol B and bisphenol F.

28. The reaction resin system as recited in claim 11, which is capable of impregnating electrical windings.

29. The reaction resin system as recited in claim 11, which is capable of encapsulating of high-voltage actuators.

30. The reaction resin system as recited in claim 11, which is capable of being used as a laminating resin.
